(19) United States
(12) Patent Application Publication
(10) Pub. No.: US 2009/0102971 A1
(43) Pub. Date: Apr. 23, 2009

(54) METHOD AND APPARATUS FOR AUTOMATIC STARTUP AND SHUTDOWN INCLUDING AUTOMATIC SOURCE SWITCHING

(75) Inventors: Darwin Chang, Santa Fe Springs, CA (US); Hing S. Tong, Santa Fe Springs, CA (US); Shi Kuang Tan, Santa Fe Springs, CA (US)

Correspondence Address: KLEINBERG & LERNER, LLP, 2049 CENTURY PARK EAST, SUITE 1080, LOS ANGELES, CA, 90067, US

(73) Assignee: WESTINGHOUSE DIGITAL ELECTRONICS, LLC, Santa Fe Springs, CA (US)

(21) Appl. No.: 11/683,400

(22) Filed: Mar. 7, 2007

Related U.S. Application Data
(60) Provisional application No. 60/780,298, filed on Mar. 8, 2006.

(51) Int. Cl. H04N 3/27; G09G 5/00

(52) U.S. Cl. 348/554; 345/211; 348/E03.049

(57) ABSTRACT

A method and apparatus for automatic startup and shutdown including automatic source selection is provided for the selection of one of many video input sources provided on a visual display device in response to a new video signal being transmitted over a particular input port. The visual display device is also provided with means to power on the television in response to user input or a new video signal input source detection. The television may automatically revert to the previously-viewed source upon the powering off or lack of signal from the most newly-acquired video signal source.

### CROSS-REFERENCE TO RELATED APPLICATIONS

The present invention claims priority on the basis of U.S. provisional patent application with Ser. No. 60/780,298 filed Mar. 8, 2006 and entitled “Method and Apparatus for Automatic Startup and Shutdown Including Automatic Source Selection” which is incorporated herein in its entirety by reference.

Reference is also made to the prior U.S. non-provisional application with Ser. No. 10/965,337 filed Oct. 14, 2004 entitled “Television with Automatic Input Switching” which is incorporated herein in its entirety by reference.

### BACKGROUND

1. Field of the Invention

The present invention relates to televisions and other devices capable of displaying video or still images. More specifically, the present invention is a method and apparatus for automatic startup and shutdown including automatic source switching.

2. Description of the Related Art

There exist other methods and apparatus in the prior art whereby a user may manually select a video signal source from among a group of sources labeled esoterically with phrases like “INPUT 1” and “HDMI 2.” There also exist methods and apparatus whereby a television may be programmed to automatically “power on” or “power off” according to a timer or pre-selected time frame.

However, there exist no methods in the prior art whereby a video signal source may be automatically detected, the television powered-on and the signal source automatically switched by the television to the new video signal. For these reasons, there exists in the prior art a need. The prior art provides no method whereby video signal source selection is as simplified or as easily controlled without the input of a user.

### SUMMARY OF THE INVENTION

The invention provides a method and apparatus for automatic startup and shutdown including automatic source selection. The preferred embodiment of the present invention provides numerous benefits over the prior art.

The present invention provides means by which a television (or other display) may be aware of any video signals coming into the television. It further provides that the television may react to the initiation of new or changed video input signals. The television (or other display) may react to those new video input signals by automatically powering on the television and/or automatically switching the televisions video input that is displayed on screen to that of the newly-initiated video signal input.

The present invention also provides means by which a user depressing a button or buttons on a remote control device may power on the television if it is not already powered on and may then carry out the instructions input by the user.

Finally, the present invention provides means by which, in the sudden absence of a video signal after a video signal has included video data, the television may automatically power off immediately or may begin a timer to power off. This enables the television to respond to the lack of a video signal on a particular video input source and to save power. Alternatively the television may automatically revert to a previously-active video signal input.

It is therefore an object of the present invention to ease the use of television inputs that are growing in number and complexity. It is a further object of the present invention to automatically switch to a newly-available video input upon its availability. It is a further object to automatically power-on the television in response to newly-available video input signals from one or more video inputs.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a detailed schematic of the circuitry used to accomplish the method of the invention.

FIG. 2 is a schematic of the analog to digital video conversion used in the method of the invention.

FIG. 3 is a flowchart of the source-detection methodology employed in the invention.

FIG. 4 is a flowchart of the automatic shutdown sequence used in the invention.

FIG. 5 is a flowchart of the remote control automatic startup and command queuing method used in the present invention.

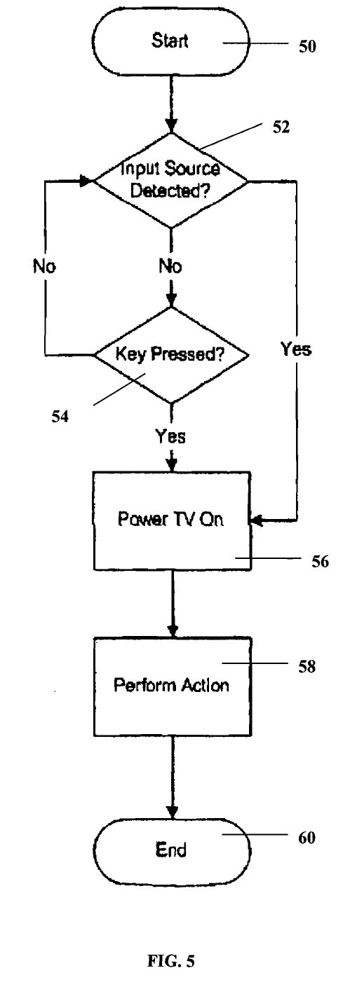

### DETAILED DESCRIPTION OF THE INVENTION

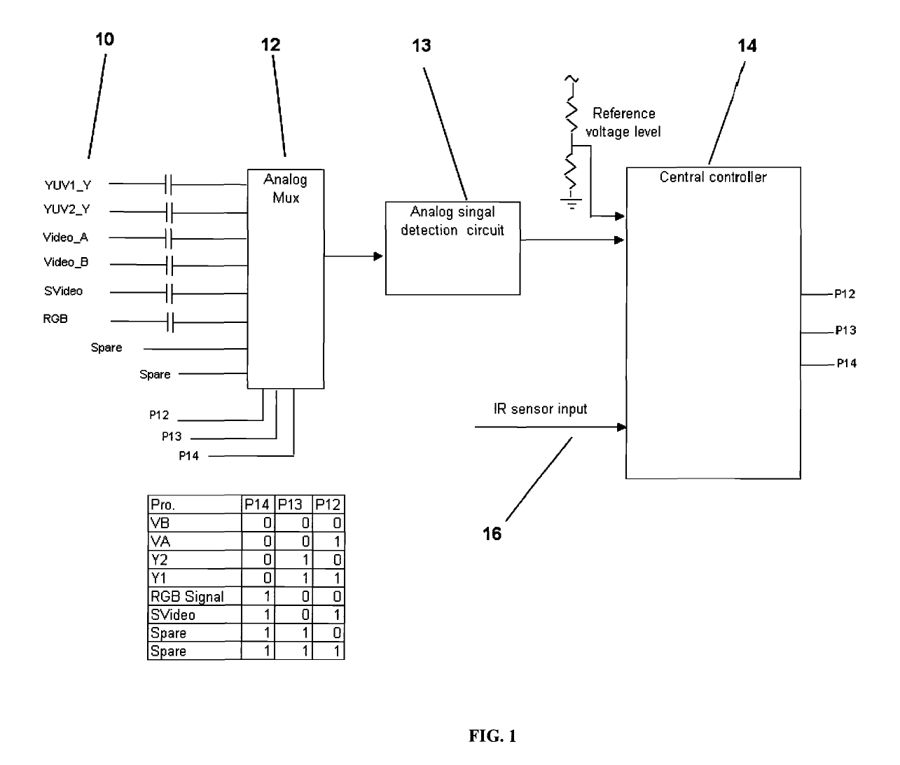

Turning first to FIG. 1, the entire circuitry used to implement the method of this invention is disclosed. The circuitry schematic is quite detailed and includes circuitry designed to implement methods for the automatic source detection, the automatic power on in response to a new video source, remote control “any button push” power on and command execution and timed power off after a video input source is no longer available.

Specifically, the apparatus disclosed includes the following key components and their functions.

The first is a series of inputs 10. These inputs range in type from analog inputs to digital inputs. There are component video input cables, DVI cables, HDMI inputs and various other input means may be employed.

The next element is a control circuit designed to receive those inputs and forward them on to the central display control chip 14. In the prior art the control chip 14 includes only means to actively select between various inputs. The default input, of course, is input one for most displays, designed to display cable or satellite broadcasting. Other inputs must be selected manually, by means of a remote control.

In the present invention, the control chip 14 includes means to detect voltage levels in the various inputs. The control chip 14 in this invention continuously checks to determine if the voltage registered by a particular input is higher than the reference voltage for that input. If so, the method of this invention registers that spike or continuously higher voltage as a new video signal and acts according to the methodology described herein.

Finally, various control inputs 16 are depicted. Similarly, the control chip 14 of the present invention is capable of receiving input, even while “powered off” and to translate that input into a command to power on and then execute the command. The control chip 14 contains a cache wherein it may receive and store commands, even while the television is “powered off” for execution after power on.

Additionally, the control chip 14 contains a timer connected to a mechanism for powering down the television such that it may power off the television in response to a lack of video input after a user-determined period of time.

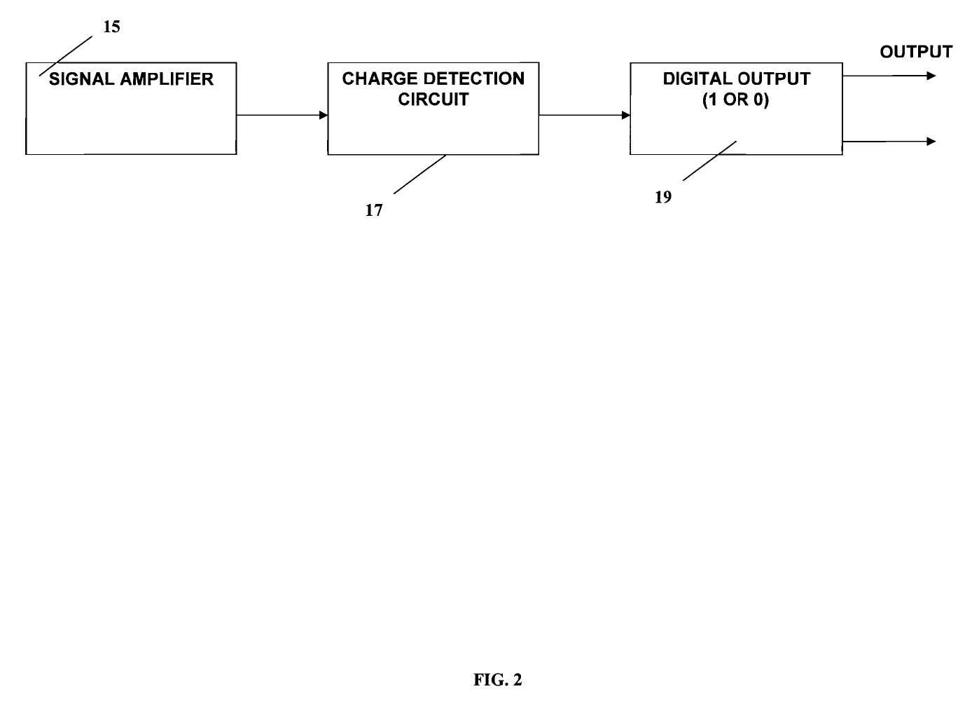

FIG. 2 is a depiction of a circuit used in part to convert analog video signals into digital signals. The circuit is used for any of the analog inputs provided on an otherwise-digital television such that the control circuit 14 which detects the voltage and compares it to the expected reference voltage may detect new video signals on non-digital sources. The functionality of this circuit will be readily understood by one skilled in the art.

The detection means, in the preferred embodiment is centralized, detecting on all video signal inputs at once and in all-digital form. In other embodiments, multiple detection circuits may be provided or one for each input type instead. These methods may not employ a conversion from analog to digital prior to the detection of new video signal input.

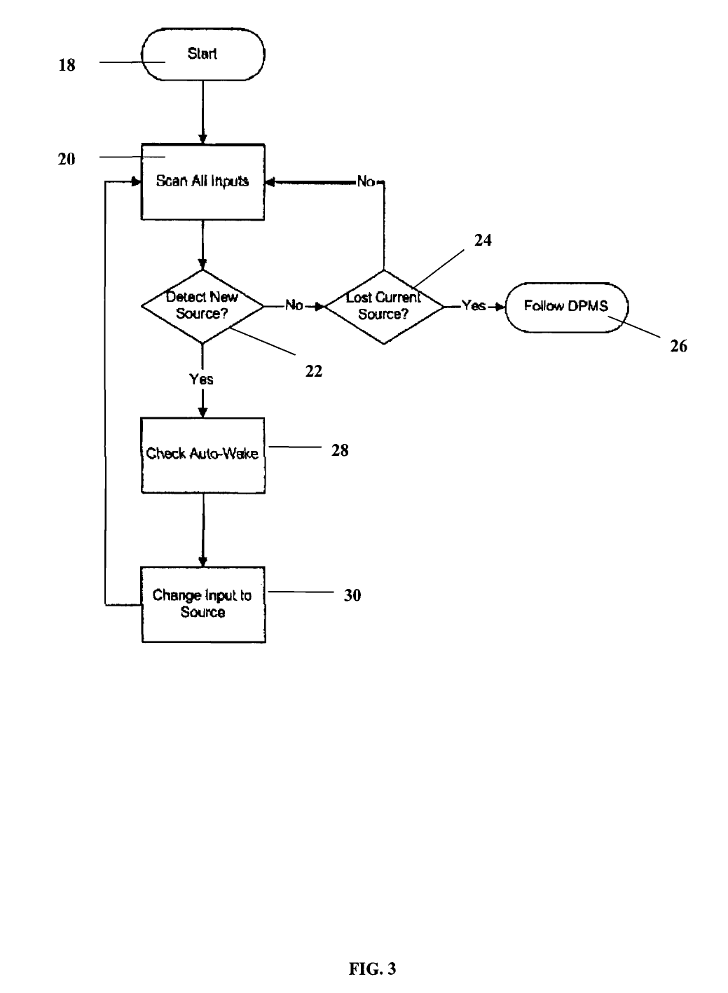

FIG. 3 is a depiction of steps involved in the process of automatic detection of new video input sources. The first step 18 is to start the process. In the preferred embodiment, the process will be continually running as the television (or other display device) has access to a power source. The television need not necessarily be “on” and in fact, in the preferred embodiment, may take these steps while not “on” but while in a standby mode.

While the process is running, the next step 20 is to scan all inputs. During this process, as described above, the voltage coming into the television is continuously monitored to determine if it is above the expected reference voltage. The comparator in the control chip 14 (see FIG. 1) is used to determine if the voltage is higher than expected. If the voltage is higher than expected, then that is a new source.

The next step 22 is to detect a new source. During this step the results of the higher than expected voltage in a particular input is determined to indicate that a new source has been found. If there is no higher than expected voltage, then the next step 24 is to determine if the current source has been lost. If there is no longer or never was a current source, the next steps 26 involve following the DPMS (Digital Power Management System). It is described more fully below.

If a higher than expected reference voltage is discovered, then the next step 28 is to check the automatic wake feature to determine if the television is on or off, currently. If the television is off, the television is turned on, automatically, and the next step is begun.

If the television is already powered on, then the next step 30 is to change the input selection to the new source. This step automatically, without user input, selects the newly-available video input source and begins displaying the output of that source to the user. As described above, by turning on the television (if necessary) and switching its input circuit to that source.

Turning now to FIG. 3, a flowchart of the steps involved in the DPMS system are shown. The first step 32 is to start the process. This step is ongoing so long as the television is in a powered on mode. The next step 34 is to detect an input signal. The television, using the reference voltage on each of the video inputs, determines if there is any video input signal on any of the video inputs. If this is the case, it cycles and continues to check that there is a video input.

If there is not a video signal on any of the video inputs, then the method carries out the next step 36 to determine if the user has taken any action recently. This checks to see whether the remote control has been used or the television turned on, volume moved up or down and other similar actions. If so, the television remains on and continues to check for a signal.

If there is no current input signal and no actions have recently been taken by a user, the next step 38 begins. In this step the DPMS timer is set, in the preferred embodiment based upon user settings. This sets a timer, for example, for 30 seconds after which the timer will timeout.

The next step 40 is to await the timer timeout. If this occurs, then the next step 42 is to power off the television and the final step 44 is to end the DPMS process. This is a method designed to save power through active discernment of television signals. If no signal is present and no user is working with the television, the television automatically shuts itself down after a period of time.

If there is no timer timeout, then a second check is made in the next step 46 to determine if there is user action. If there is no user action, then it reverts to the previous step 40 to determine if there has been a timer timeout. If there is user action, then the next step 48 is to reset the DPMS timer and to return to the step 34 for determining if there is any input signal.

This method enables a user to use the television with or without signal while manipulating the television. However, should a user no longer be using the television and the television no longer be receiving any signal from any input, the television will automatically shut itself down after a timeout, as pre-determined by a user.

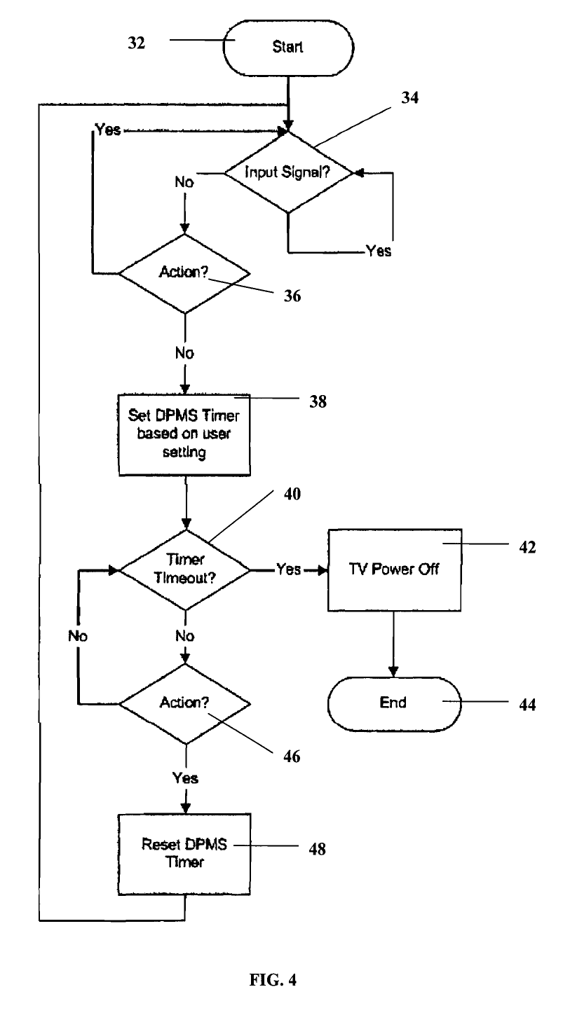

Turning now to FIG. 4, a flowchart of the steps involved in the remote control command queuing and automatic power on system are shown. The first step 50 is the start. This method will be on-going while the television (or other display) has access to a power source.

The next step 52 is to determine whether an input source is detected. Using methodology described above, the television determines if there is an input source currently providing video signal. If there is no input source detected, the next step 54 is to determine if a key has been pressed on the remote or on the face (or side) of the television. If not, then the method of this invention reverts to the previous step 52 of input source detection.

If there is an input source detected in step 52 or there is a key pressed in step 54, then the next step 56 is to power the television on. The next step 58 performs the action requested by the user (if there is one) for example a queued remote control button press or series of buttons. The hardware of the television is provided with a small cache capable of queuing commands, even while in “power off” mode such that they may be executed, after detection, once the television has been powered on.

This means that should a new input source become active, the television will power itself on and select that input source. Alternatively, if a key is pressed by a user, the television will power itself on and perform the action requested by the user. Finally, the last step 60 is to end the process once the television is on and the commands have been executed.

Under any of these methods depicted, once an input source or video signal source have become inactive, the television (or other video display device) may revert to its previous source or, if none were present, shutdown after a user-defined timeout. This will allow a user to insert a DVD, begin playing, shut down the DVD player after the movie is over and have the television automatically revert to the previously-selected source such as a broadcast or cable television input source.

Accordingly, a method and apparatus for automatic startup and shutdown including automatic source switching has been described. It is to be understood that the word “television” is intended to refer generally to a display device and may include computer monitors, computers, large screen displays, movie theatre displays, projectors, and other means of creating video displays based upon video input sources.

It is to be understood that the foregoing description has been made with respect to specific embodiments thereof for illustrative purposes only. The overall spirit and scope of the present invention is limited only by the following claims, as defined in the foregoing description.

What is claimed is:

1. A method for selecting a video input source to be automatically displayed on a visual display device comprising:
detecting a new input source; and
selecting automatically said input source for display on the visual display device.

2. The method of claim 1 further comprising the initial step of scanning input sources on the visual display device for a new input source.

3. The method of claim 1 further comprising the intermediate steps of:
determining the power state of the visual display device; and
if the visual display device is currently off, automatically powering on the visual display device prior to said selecting step.

4. The method of claim 1 further comprising the final steps of:
detecting when no signal source is available; and
beginning an automatic shutdown timer.

5. A method of automatically shutting down a visual display device, using a timer, based upon user action and source input availability, comprising the steps of:
detecting whether or not input sources exist;
detecting whether or not a user has performed any action;
setting a timer set to expire; and
upon expiration of the timer, turning the visual display device off.

6. The method of claim 5 further comprising the additional step of continually checking for user action prior to the expiration of said timer.

7. The method of claim 6 further comprising the additional step of returning to said detecting whether or not input sources exist step in response to user action prior to the expiration of said timer.

8. The method of claim 7 further comprising the step of resetting said timer in response to user action prior to the expiration of said timer.

9. A method of powering on a visual display device in response to user action or new video signal input source comprising:
detecting new video signal input source;
detecting a key press on a remote or on the visual display device; and
powering on the visual display device in response to said new video signal input or said key press.

10. The method of claim 9 further comprising the additional step of performing the pre-programmed action associated with said key press.

11. An apparatus for selecting a video input source to be automatically displayed on a visual display device comprising:
a video input;
detection means, connected to said video input, for detecting a new video signal input source; and
selection means, connected to said detection means, for selecting automatically said new video signal input source for display on the visual display device.

12. The apparatus of claim 11 further comprising scanning means, connected to said video input and said detection means, for scanning said video input on the visual display device for a new video signal input source.

13. The apparatus of claim 11 wherein the video display device further comprises:
display state status means for determining the power state of the visual display device; and
responsive power means, connected to said display state status means, for automatically powering on the visual display device if the display is off in response to said new video signal input source.

14. The apparatus of claim 11 wherein said detection means is also capable of detecting when no signal source is available and further comprising a timer means, connected to said detection means, for beginning an automatic shutdown timer.

15. An apparatus for automatically shutting down a visual display device based upon user action and source input availability, comprising:
first detection means for detecting whether or not input sources exist;
second detection means for detecting whether or not a user has performed any action;
timer means, connected to said first and second detection means, for setting a time at which the visual display device will be shutdown; and
shutdown means, connected to said timer means, for turning the visual display device off.

16. The apparatus of claim 15 further wherein said second detection means continually checks for user action prior to the expiration of said timer.

17. The apparatus of claim 16 wherein said first detection means further continuously checks whether or not input sources exist prior to the expiration of said timer.

18. The apparatus of claim 17 wherein said timer is reset in response to user action prior to the expiration of said timer.

19. An apparatus for powering on a visual display device in response to user action or new video signal input source comprising:
first detection means for detecting new video signal input source;
second detection means for detecting a key press on a remote or on the visual display device; and
startup means, connected to said first and second detection means, for powering on the visual display device in response to said new video signal input or said key press.

20. The apparatus of claim 19 further comprising queuing means for performing the pre-programmed action associated with said key press.
